(19) United States
(12) Patent Application Publication
(10) Pub. No.: US 2005/0076955 A1
(43) Pub. Date: Apr. 14, 2005

(54) Pressure-relief valve

(76) Inventors: Peter Boehland, Marbach (DE); Godehard Nentwig, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/488,471

(22) PCT Filed: Mar. 3, 2003
(86) PCT No.: PCT/DE03/00690

(30) Foreign Application Priority Data
Jul. 10, 2002 (DE) 102 31 135.8

(51) Int. Cl. F16K 15/18

(52) U.S. Cl. 137/539.5

(57) ABSTRACT

A pressure relief valve with a closing element which can be moved axially in the opening direction in a bore in opposition to the force of a closing spring acting in the closing direction wherein when the pressure relief valve is closed, the closing element rests against a valve seat and closes an inlet and wherein a piston is integrated into the inlet is connected to the closing element by means of a connecting element and can be moved axially in the inlet.

### TECHNICAL FIELD

Pressure relief valves in the form of ball valves, in which a spring presses a ball against a seat, are frequently used to regulate pressure and prevent excess pressure in pressurized systems. Ball valves have the advantage that they reliably and imperviously seal the seat even at high pressures of the kind that are typical, for example, in diesel injection systems.

### PRIOR ART

In the prior art, ball valves have been used, for example, in pressure regulating valves for accumulator fuel injection systems of internal combustion engines. A pressure regulating valve of this kind is known, for example, from the manual Diesel Motor Management, 2^{nd} edition, published by Verlag Vieweg, 1998, pp. 270, 271. The function of such a pressure valve is to set and maintain the pressure in a fuel accumulator as a function of the load state of the motor. Two control loops are used for this, a slower electrical one that uses an electromagnet and a faster mechanical one that uses a ball valve. The slow control loop sets an adjustable average pressure value in the high-pressure accumulator and the fast control loop compensates for high-frequency pressure oscillations.

For a large number of uses, however, including the use in the above-mentioned pressure regulating valve among others, ball valves from the prior art, due to their design principle, have the disadvantage that the opening force that the fluid pressure exerts on the ball in the opening direction decreases as the valve stroke increases. This will be explained in more detail below in conjunction with FIG. 1.

FIG. 1 schematically depicts a ball of a ball valve, which seals an opening 2 when the valve is closed. A high pressure prevails in the opening 2, which exerts a force on the ball 1 in the opening direction 3. This static pressure decreases sharply in the region of the valve seat, an enlargement of which is depicted in FIG. 1. For example, calculations based on simulations show a pressure decrease in this region A of 10⁸ Pa to 10⁰ Pa. With the stroke of the ball 1 during the opening of the ball valve, this pressure decrease results in a force reduction of typically 30 to 60% of the hydrostatic force acting on the ball 1 when the valve is closed. The reduced force on the valve results in a smaller valve stroke, which limits the flow.

### DEPICTION OF THE INVENTION

The ball valve according to the invention avoids the disadvantages inherent in the prior art and makes it possible to achieve an improved function with regard to the stroke/pressure curve. It is advantageously possible for the above-described decrease in pressure against the closing element of a pressure relief valve, in particular against the ball of a ball valve, to be compensated for by means of the stroke. This makes it possible to significantly increase the flow through the valve. It is simultaneously possible to embody additional features such as a switching hysteresis. The pressure relief valve according to the invention can be produced easily and without incurring high manufacturing costs.

These advantages are achieved according to the invention by means of a pressure relief valve with a closing element that can be moved axially in the opening direction in a bore, in opposition to the force exerted in the closing direction by a closing spring; when the pressure relief valve is closed, the closing element rests against a valve seat and closes an inlet. In addition, a piston is integrated into the inlet, which piston is connected to the closing element by means of a connecting element and can be moved axially in the inlet.

When the pressure relief valve is additionally equipped with the piston incorporated into the inlet, the piston transmits an additional opening force to the closing element. This force exists only when the pressure relief valve is open. When the pressure relief valve is open, the piston functions as a throttle in the inlet so that a pressure difference is produced between the two ends of the piston. When the pressure relief valve is open, a force therefore acts on the piston, pushing it in the direction of the closing element and causing the pressure relief valve to open even further.

The pressure relief valve according to the invention is preferably a ball valve with a ball-shaped closing element. However, other forms of closing elements are also possible, for example a plate-shaped, conical, or piston-shaped closing element.

The subject of the current invention also includes a pressure regulating valve that contains a pressure relief valve according to the invention, with a piston-shaped valve element that can be moved axially in a bore and that acts on the closing element; in addition to the closing spring, an electromagnet is provided, which can exert a force on the closing element in the opening direction or closing direction by means of the valve element.

Preferably, a pressure relief valve of this kind is used to regulate the pressure in a high-pressure fuel accumulator or at the outlet of a high-pressure fuel pump in an internal combustion engine with an accumulator fuel injection system.

### DRAWINGS

The invention will be explained in detail below in conjunction with the drawings.

FIG. 1 shows a schematic depiction of a ball valve from the prior art,

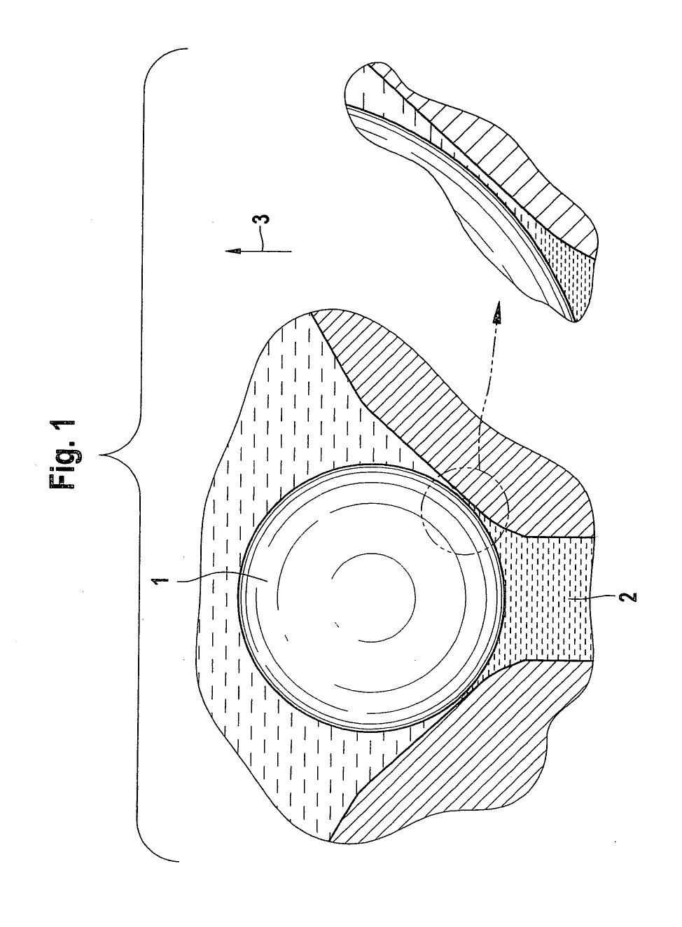

FIG. 2 shows a pressure relief valve according to the invention when closed and when open,

FIG. 3 shows another embodiment form of a pressure relief valve according to the invention,

FIG. 4 shows a pressure regulating valve according to the invention,

FIG. 5 shows the pressure in a rail and upstream of a pressure regulating valve according to the invention and shows the stroke of the closing element of this pressure regulating valve, and

FIG. 6 shows the pressure and the stroke in an opening and closing process of a pressure regulating valve according to the invention, with hysteresis.

### EMBODIMENT VARIANTS

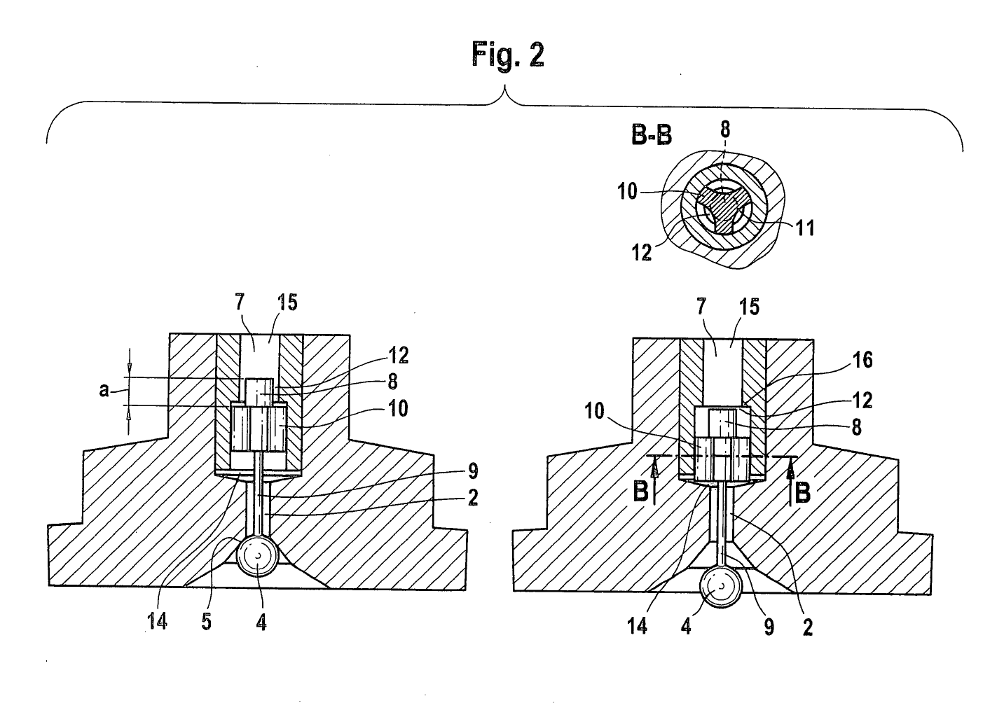

FIG. 2 shows a section through a pressure relief valve according to the invention, when closed and when open.

The left half of FIG. 2 shows a closed pressure relief valve and the right half shows an open one. The pressure relief valve includes a ball-shaped closing element 4, which when the valve is closed, closes an opening 2 by resting against a valve seat 5. Inside the valve housing 6, the end of the opening 2 oriented away from the closing element 4 feeds into an inlet 7. According to the invention, a piston 8 is integrated into the inlet 7 and is connected to the closing element 4 by means of a connecting element 9 that extends through the opening 2. In addition, a guide element 10 is disposed between the connecting element 9 and the piston 8. In this preferred embodiment of the current invention shown in FIG. 2, the piston 8 is connected to the guide element 10, which guides the piston 8 in the inlet 7. In the current invention, preferably a polygonal guide serves as the guide element 10, as shown in the section B-B through the guide element 10 in the right half of FIG. 2. In the current invention, the guide element 10 does not represent a throttle restriction. In the preferred embodiment of the polygonal guide, for example, indentations 11 permit a rapid pressure compensation between the two ends of the guide element 10.

However, an annular gap 12 between the circumference surface of the piston 8 and the circumference surface of the inlet does in fact a represent a throttle restriction.

A fluid whose pressure is regulated by the pressure relief valve exerts a continuous pressure in the opening direction on the closing element 4 via the opening 2. When the valve is closed, the closing element 4 is pushed into the valve seat 5 by the force of a closing spring 13 (not shown) and possibly by other forces acting in the closing direction. If the hydrostatic force of the fluid that acts in the opening direction on the seat surface of the closing element 4 exceeds the spring force of the closing spring 13 (not shown) plus other forces acting in the closing direction on the closing element 4, then the closing element 4 moves away from its seat 5. The fluid then flows out through the opening 2, past the valve seat 5. The static pressure in the first inlet chamber 14 decreases since the flow is throttled by the annular gap 12. This generates a pressure difference between the two inlet chambers 14 and 15 that are separated by the piston 8. The higher pressure in the second inlet chamber 15 oriented away from the closing element 4 relative to the pressure in the first inlet chamber 14 oriented toward the closing element 4 exerts a force in the opening direction on the piston 8. As a result, the piston 8 pushes on the closing element by means of the guide element 10 and the connecting element 9. This opening force causes a further movement of the closing element 4 in the opening direction so that the opening 2 is opened even farther. This permits a significant increase in the fluid flow through the pressure relief valve. The pressure in the first inlet chamber 14 decreases even further and the pressure difference between the two inlet chambers 14, 15 intensifies the opening effect until a force acting on the closing element 4 in the closing direction exceeds the force in the opening direction and the closing element 4 moves back toward the valve seat 5. This sufficiently powerful force in the closing direction can, for example, be generated by the progression of the closing spring 13 (not shown).

In the preferred embodiment form of the current invention shown in FIG. 2, the inlet 7 has regions with different inlet diameters. At the end of the inlet 7 oriented toward the opening 2, there is a cross-sectionally enlarged region that contains, among other things, the guide element 10. In addition, in this preferred embodiment form of the pressure relief valve according to the invention, when the pressure relief valve is closed, the piston 8 protrudes with at least a part of its length a into another region of the inlet 7 with a smaller inlet diameter. As the pressure relief valve opens, the piston 8 travels into the region of the inlet 7 with the larger inlet diameter. As a result, when the valve is closed (left half of FIG. 2) and the piston 8 protrudes into the region of the inlet 7 with the smaller inlet diameter, the annular gap 12 is narrow and powerfully throttles the flow from the second inlet chamber 15 into the first inlet chamber 14. When the pressure relief valve is open (right half of FIG. 2), the annular gap 12 between the circumference surface of the piston and the circumference surface of the inlet is wider because the piston 8 has moved into the region with the larger inlet diameter (by the distance a in this case). As a result, more fluid flows through the wider annular gap 12 so that the pressure difference between the two inlet chambers 14, 15 decreases or reaches equilibrium. This effect, as with the progression of the spring, limits the opening action due to the pressure difference between the two inlet chambers 14, 15 that enclose the piston 8. If the hydrostatic pressure of the fluid in the inlet 7 decreases, the spring force of the closing spring 13 (not shown) and other possible forces acting in the closing direction overcome the opening forces acting on the piston 8 and the losing element 4 so that the pressure relief valve closes.

In this preferred embodiment of the current invention, the region of the inlet 7 with the smaller inlet diameter transitions by means of a step into the region of the inlet 7 with the larger inlet diameter (step 16).

In a preferred embodiment of the current invention (not shown), the piston 8 has a piston diameter that is smaller in a part of the piston 8 oriented toward the closing element 4 than in a part of the piston 8 oriented away from the closing element 4. The piston is therefore the shape of a truncated cone, for example. This shape influences the opening and closing behavior of the pressure relief valve. With a piston 8 the shape of a truncated cone, the flow cross section of the annular gap throttle restriction 12 increases uniformly with the stroke. The pressure difference between the first inlet chamber 14 and the second inlet chamber 15 decreases by the same amount. Consequently the force of pressure (=additional opening force) that the piston 8 transmits to the closing element 4 by means of the guide element 10 and the connecting element 9 decreases until the piston 8 comes all of the way out and the additional opening force falls to zero.

In addition, the closing behavior of the pressure relief valve according to the invention can be influenced by sizing the piston diameter in proportion to the diameter of the valve seat 5. In a preferred embodiment form of the current invention, the piston 8 has a (maximal) piston diameter that is greater than the diameter of the valve seat 5. If the piston diameter exceeds the seat diameter significantly, then when the pressure relief valve closes, a hysteresis is produced, i.e. the pressure relief valve closes at a pressure level of the fluid that lies below the opening pressure.

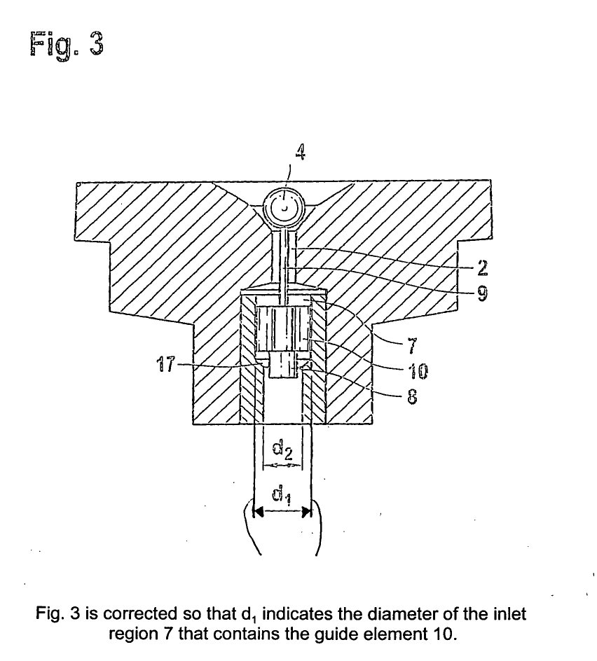

FIG. 3 shows a section through another preferred embodiment of a pressure relief valve according to the invention.

The design of this pressure relief valve largely corresponds to the pressure relief valve depicted in FIG. 2. A ball-shaped closing element 4 is connected to a piston 8 in the inlet 7 by means of a guide element 10 and a connecting element 9 extending through an opening 2. The inlet 7 has a part with a larger inlet diameter d₁ that is oriented toward the opening 2 and transitions into a part with a smaller inlet diameter d₂. In this preferred embodiment form of the current invention, the inlet 7 widens from the smaller inlet diameter d₂ to the larger inlet diameter d₁ in a conical transition region 17. As a result of the conical transition region 17, the additional opening force decreases uniformly as the piston 8 travels out of the second inlet chamber 15 (by contrast with the step-shaped transition region).

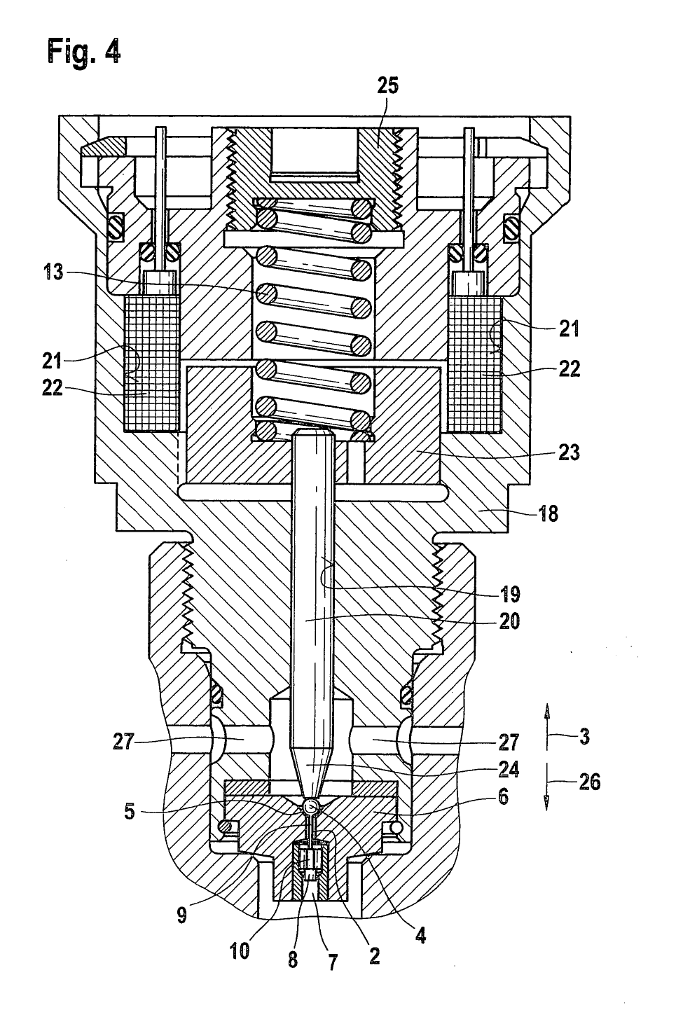

FIG. 4 shows a section through a pressure regulating valve according to the invention.

The pressure regulating valve is preferably provided for setting the pressure in a fuel accumulator (rail, not shown) of a common rail injection system. The pressure regulating valve has a valve body 18 that contains a bore 19. A piston-shaped valve element 20 is disposed so that it can move axially in the bore 19. The valve body 18 also has an annular chamber 21 that contains an electromagnet 22 with a coil winding. The one end of the valve element 20 is connected to a magnet armature 23 whose volume is partially encompassed by the annular chamber 21 containing the electromagnet 22. At its one end, the bore 19 has a region with an enlarged diameter that contains a valve housing 6 of a pressure relief valve according to the invention. The opening 2 and the inlet 7 of this pressure relief valve according to the invention are disposed coaxial to the bore 19 in the pressure regulating valve. The end region 24 of the valve element 20 oriented away from the magnet armature 23 tapers conically. A closing spring 13 disposed coaxial to the valve element 20 is supported at one end against the magnet armature 23 and at the other end, is supported in a recess 25 in the valve body 18. The closing spring 13 is prestressed and exerts a continuous force in the closing direction 26 on the valve element 20, which in turn pushes a ball-shaped closing element 4 of the pressure relief valve in the closing direction 26.

If the electromagnet 22 is without current, then only the closing force of the closing spring 13 acts on the closing element 4 by means of the valve element 20 and pushes the closing element 4 against its valve seat 5. The pressure that prevails, for example, in a fuel accumulator (not shown) acts on the closing element 4 by means of the inlet 7; this pressure exerts a force on the closing element 4 that counteracts the force of the closing spring 13. If this pressure-induced force in the opening direction 3 exceeds the force of the closing spring, then the closing element 4 lifts up from the valve seat and moves in the opening direction 3 along with the valve seat 20 and the magnet armature 23 on the one hand and the connecting element 9, the guide element 10, and the piston 8 on the other. When the pressure regulating valve is open, the opening force increases even further according to the invention in the above-explained manner due to the force on the piston 8. Fluid (for example fuel) flows out through the inlet 7, the opening 2, the valve seat 5, and discharge openings 27 in the valve body 18, into a discharge chamber (not shown), for example a fuel tank.

In the embodiment form of a pressure regulating valve according to the invention shown in FIG. 4, when the electromagnet 22 is supplied with current, it acts in the opening direction in opposition to the spring force of the closing spring. When the electromagnet 22 is not supplied with current, then a very high pressure in the inlet 7 is required to open the pressure regulating valve, which pressure is defined by the force of the closing spring 13. In order to reduce the pressure required for opening, the electromagnet 22 is supplied with current. Then the magnetic force acting on the magnet armature 23, which is transmitted by the valve element 20, acts on the closing element 4 in the opening direction 3 in opposition to the force of the closing spring 13. The pressure relief valve opens only after the opening force exerted by the pressure in the inlet 7 and by the electromagnet 22 exceeds the force exerted by the closing spring 13. The magnetic force that the electromagnet 22 exerts on the magnet armature 23 is regulated by means of the amperage supplied to the electromagnet. This amperage is regulated by a control unit (not shown), which sets the amperage as a function of the pressure required in the system (for example a fuel accumulator) that is connected to the inlet.

In other embodiment forms of the pressure regulating valve according to the invention (not shown), when the electromagnet 22 is supplied with current, it works in concert with the spring force of the closing spring 13, acting on the closing element 4 in the closing direction 26. When the electromagnet 22 is not supplied with current, then a pressure that is already present in the inlet 7 is sufficient to open the pressure regulating valve, which pressure is defined only by the force of the closing spring 13. In order to increase the pressure required for opening, the electromagnet 22 is supplied with current. Then, in addition to the force of the closing spring 13, the magnetic force acting on the magnet armature 23, which is transmitted by the valve element 20, also acts on the closing element 4 in the closing direction 26. The pressure relief valve opens only after the opening force exerted by the pressure in the inlet 7 exceeds this force generated by the closing spring 13 and the electromagnet 22.

It is also conceivable for there to be a variant of a pressure regulating valve in which a spring acts in the opening direction and an electromagnet acts in the closing direction when supplied with current.

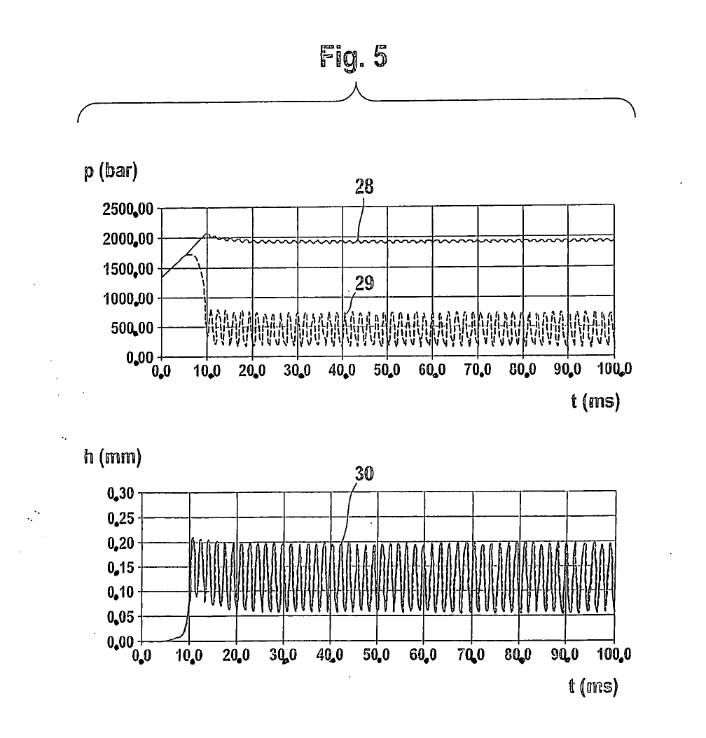

The upper part of FIG. 5 depicts the pressure in a fuel accumulator (rail) and the pressure upstream of a pressure regulating valve according to the invention and the lower part depicts the stroke of the closing element of the pressure regulating valve.

In the graph shown in the upper part of FIG. 5, the pressure p in bar is plotted on the y-axis and time t in ms is plotted on the x-axis. The graph shows two curves. Curve 28 represents the development of the pressure in a fuel accumulator that is regulated by a pressure regulating valve according to the invention. Curve 29 represents the pressure upstream of the pressure regulating valve (in its opening 2). In this case, a rail of a diesel injection system has been simulated, in which a pump delivers a constant supply quantity of 350 l/h. The desired opening pressure of the valve, which is defined by the magnetic force and the closing spring force, is 1700 bar. The valve opens correctly at this pressure. The stroke h of the closing element of the valve, which is represented by the curve 30 plotted in the lower part of FIG. 5, oscillates between 0.05 mm and 0.2 mm. The stroke 30 increases due to the opening force acting on the closing element and the piston connected to it in the inlet of the pressure regulating valve until the progression of the closing spring and the cross sectional enlargement in the inlet cause the opening force—and therefore also the stroke—to decrease again starting at a particular stroke of the closing element (0.2 mm here). The stroke then increases again until the opening force decreases again (for example due to the high pressure on the piston in the narrower part of the inlet). In this example, after a pressure peak of approximately 2050 bar, the rail can contain a pressure of approximately 1950 bar. Without the pressure regulating piston, the valve would open with significantly less of a stroke due to the drop in pressure against the ball. As a result, a pressure of approximately 3300 would occur in the rail.

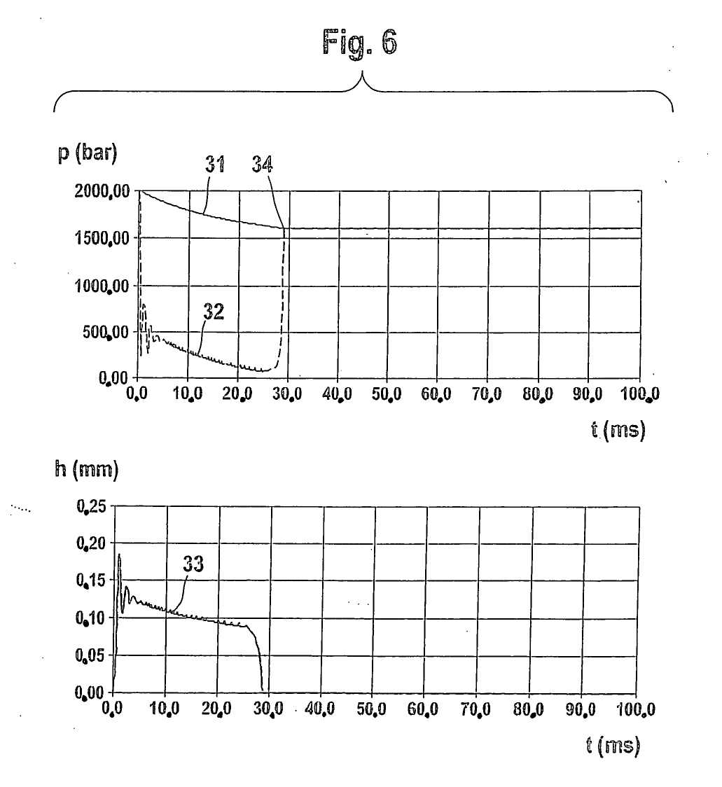

FIG. 6 shows the pressure and the stroke in an opening and closing process of a pressure regulating valve according to the invention, with hysteresis.

In the upper part of FIG. 6, the pressure p in bar is plotted over time t in ms. Curve 31 represents the pressure curve in the rail, curve 32 represents the pressure curve upstream of the pressure regulating valve according to the invention. In the lower part of FIG. 6, the curve of the stroke of the closing element of this pressure regulating valve is plotted as a function of time t in ms. As in FIG. 5, the valve opens at a rail pressure 31 of approximately 1700 bar. After the pressure peak of approximately 2050 bar when the valve is open, the rail pressure 31 drops until it reaches the closing point 34 at which the pressure regulating valve closes. In this case, the matching of the piston diameter in relation to the seat diameter is selected so that the valve closes again with a slight hysteresis at slightly above 1600 bar. Without a pressure regulating piston, the valve would close without hysteresis at 1700 bar.

Reference Numeral List

1 ball
2 opening
3 opening direction
4 closing element
5 valve seat
6 valve housing
7 inlet
8 piston
9 connecting element
10 guide element
11 indentations
12 annular gap
13 closing spring
14 first inlet chamber
15 second inlet chamber
16 step
17 conical transition region
18 valve body
19 bore
20 valve element
21 annular chamber
22 electromagnet
23 magnet armature
24 end region of valve element
25 recess
26 closing direction
27 discharge openings
28 pressure in fuel accumulator
29 pressure upstream of pressure regulating valve
30 stroke
31 pressure in rail
32 pressure upstream of pressure regulating valve
33 stroke
34 closing point

1-12. (canceled).

13. In a pressure relief valve with a closing element (4), which can be moved axially in the opening direction (3) in a bore in opposition to the force of a closing spring (13) acting in the closing direction (26), wherein when the pressure relief valve is closed, the closing element (4) rests against a valve seat (5) and closes an inlet (7), the improvement comprising a piston (8) integrated into the inlet (7), the piston (8) being connected to the closing element (4) by means of a connecting element (9) and being moveable axially in the inlet (7).

14. The pressure relief valve according to claim 13, wherein the closing element (4) is ball-shaped.

15. The pressure relief valve according to claim 13, wherein the inlet (7) has regions with different inlet diameters.

16. The pressure relief valve according to claim 15, wherein when the pressure relief valve is closed, the piston (8) protrudes at least partway into a region of the inlet (7) with a smaller inlet diameter and when the pressure relief valve opens, travels into a region of the inlet (7) with a larger inlet diameter.

17. The pressure relief valve according to claim 16, wherein the region of the inlet (7) with the smaller inlet diameter transitions by means of a step into the region of the inlet (7) with the larger inlet diameter.

18. The pressure relief valve according to claim 16, wherein the inlet (7) widens out in a conical transition region (17) from the smaller inlet diameter to the larger inlet diameter.

19. The pressure relief valve according to claim 13, further comprising a guide element (10) connected to the piston (8), the guide element (10) guiding the piston (8) in the inlet (7).

20. The pressure relief valve according to claim 19, wherein a polygonal guide serves as the guide element (10).

21. The pressure relief valve according to claim 13, wherein the piston (8) has a piston diameter that is smaller in a part of the piston (8) oriented toward the closing element (4) than in a part of the piston (8) oriented away from the closing element (4).

22. The pressure relief valve according to claim 13, wherein the piston (8) has a piston diameter that is greater than the diameter of the valve seat (5).

23. A pressure regulating valve containing a pressure relief valve according to claim 13, the regulating valve comprising a piston-shaped valve element (20) that can be moved axially in a bore (19) and acts on the closing element (4), and an electromagnet (22) operable to exert a force on the closing element (4) in the opening direction or closing direction (26) by means of the valve element (20).

24. A use of a pressure regulating valve according to claim 23, to regulate the pressure in a high-pressure fuel accumulator or at the outlet of a high-pressure fuel pump in an internal combustion engine with an accumulator fuel injection system.
